(19) United States
(12) Patent Application Publication
(10) Pub. No.: US 2026/0344767 A1
(43) Pub. Date: Nov. 5, 2026

(54) HEATING STRUCTURE AND ELECTRONIC CIGARETTE

(71) Applicant: Caleaftech LLC, ARCADIA, CA (US)

(72) Inventors: Liyuan Jiang, Yongzhou (CN); Libing Hu, Zhangshu (CN)

(21) Appl. No.: 19/709,347

(22) Filed: Jun. 16, 2026

(51) Int. Cl. A24F 40/46; A24F 40/10; A24F 40/44; A24F 40/60; H05B 1/02

(52) U.S. Cl. CPC A24F 40/46; A24F 40/10; A24F 40/44; A24F 40/60; H05B 1/0252

(57) ABSTRACT

The present application relates to a heating structure and an electronic cigarette, comprising a housing, a heating structure, and an electronic control structure. The housing defines an oil reservoir and an atomization chamber, and the heating structure is disposed between the oil reservoir and the atomization chamber. The heating structure comprises a ceramic body and a heating wire. The ceramic body comprises a wicking portion and a fixing portion. The heating wire is fixedly disposed on a side of the fixing portion away from the wicking portion, such that e-liquid flows from the wicking portion through concave holes of the fixing portion and is then heated and atomized into aerosol by the heating wire. The present application achieves the effect of avoiding a problem in which aerosol generated from atomized e-liquid becomes burnt and develops an off-flavor due to insufficient wicking, thereby affecting taste.

### TECHNICAL FIELD

The present application relates to the field of electronic cigarettes, and more particularly to a heating structure and an electronic cigarette.

### BACKGROUND

As an electronic product simulating a conventional cigarette, an electronic cigarette is highly similar to a conventional cigarette in appearance, in the state of aerosol generated during use, and in the user's inhalation experience, and is therefore widely used as a substitute for conventional cigarettes.

Existing electronic cigarettes generally include a heating structure configured to atomize e-liquid into aerosol. The electronic cigarette is further provided with a liquid storage chamber for storing e-liquid and an atomization chamber in which the e-liquid is atomized, such that the heating structure atomizes the e-liquid in the liquid storage chamber into aerosol in the atomization chamber. The heating structure generally includes a ceramic body having micropores and a heating wire. E-liquid permeates through the ceramic body via pores of the ceramic body and is then heated and atomized into aerosol by the heating wire. In order to ensure structural strength of the ceramic body, the number of micropores in the ceramic body is generally not excessive, which in turn causes a relatively low wicking speed of the ceramic body, resulting in insufficient e-liquid delivered to the heating wire. As a result, the heating wire excessively heats the e-liquid, causing aerosol generated from the atomized e-liquid to become burnt and develop an off-flavor, thereby resulting in poor inhalation taste.

### SUMMARY

In order to avoid a problem in which aerosol generated from atomized e-liquid becomes burnt and develops an off-flavor due to insufficient wicking, thereby affecting taste, the present application provides a heating structure and an electronic cigarette.

The present application provides a heating structure and an electronic cigarette adopting the following technical solution:

A heating structure includes a ceramic body and a heating wire, wherein the ceramic body includes a wicking portion and a fixing portion, the wicking portion and the fixing portion being fixedly connected, the fixing portion defining a plurality of concave holes, and the heating wire being fixedly disposed on a side of the fixing portion away from the wicking portion, such that e-liquid flows from the wicking portion through the fixing portion and is then heated and atomized into aerosol by the heating wire.

Optionally, the heating wire extends to form a heating pin, and the heating pin is located inside the fixing portion.

Optionally, the wicking portion has a top surface away from the fixing portion, and the top surface protrudes to form an arcuate surface.

An electronic cigarette includes a housing, a heating structure, and an electronic control structure, wherein the housing defines an oil reservoir and an atomization chamber, the heating structure is disposed between the oil reservoir and the atomization chamber and is configured to heat and atomize e-liquid in the oil reservoir into aerosol in the atomization chamber, and the electronic control structure is disposed in the housing.

Optionally, the electronic control structure includes a circuit board, a battery module, and a display module, the circuit board being disposed in the housing and electrically connected to the heating structure, the battery module being disposed in the housing and electrically connected to the circuit board, the battery module being configured to supply power to the circuit board, and the display module being disposed in the housing and electrically connected to the circuit board, the display module being configured to display a status of the electronic cigarette.

Optionally, the display module includes a display unit and a reflection box, the reflection box being connected to the display unit, the reflection box having a reflective surface and a display surface, and the reflection box being configured to reflect light emitted from the display unit by the reflective surface onto the display surface for display.

Optionally, the reflection box is fixedly provided with a fixing protrusion, the housing defines a fixing groove, and when the reflection box is connected to the housing, the fixing protrusion extends through the fixing groove.

Optionally, the reflection box is fixedly provided with a snap-engaging protrusion, the housing is fixedly provided with a snap hook, and when the reflection box is fixedly disposed in the housing, the snap hook snap-engages with the snap-engaging protrusion.

In summary, the present application provides at least one of the following beneficial technical effects:

When e-liquid permeates into the ceramic body through the wicking portion, flows through the fixing portion, and is finally heated and atomized into aerosol by the heating wire, the concave holes in the fixing portion form oil storage spaces for storing e-liquid when the e-liquid flows through the fixing portion, such that when the heating wire is operating and lacks e-liquid, the concave holes rapidly provide e-liquid to the heating wire to facilitate atomization by the heating wire, thereby ensuring that the e-liquid delivered to the heating wire remains sufficient at all times. As a result, occurrence of burnt and off-flavored e-liquid caused by the heating wire is reduced, thereby ensuring flavor fidelity of the e-liquid and improving over the problem that, in order to ensure structural strength of the ceramic body, the number of micropores in the ceramic body is generally limited, which in turn results in a relatively low wicking speed of the ceramic body and insufficient e-liquid delivered to the heating wire, causing the heating wire to excessively heat the e-liquid such that aerosol generated from the atomized e-liquid becomes burnt and develops an off-flavor, thereby resulting in poor inhalation taste.

### BRIEF DESCRIPTION OF THE DRAWINGS

FIG. 1 is a schematic view of an overall structure according to an embodiment of the present application;

FIG. 2 is an exploded view of an overall structure according to an embodiment of the present application;

FIG. 3 is a schematic view of an oil reservoir structure according to an embodiment of the present application;

FIG. 4 is a schematic view of an atomization chamber structure according to an embodiment of the present application;

FIG. 5 is a schematic view of an air inlet structure according to an embodiment of the present application;

FIG. 6 is a first schematic view of an overall structure of the heating structure according to an embodiment of the present application;

FIG. 7 is a cross-sectional view of the overall structure of the heating structure according to an embodiment of the present application;

FIG. 8 is a second schematic view of an overall structure of the heating structure according to an embodiment of the present application;

FIG. 9 is an exploded view of the overall structure of the heating structure according to an embodiment of the present application;

FIG. 10 is a schematic view of an electronic control structure according to an embodiment of the present application;

FIG. 11 is a schematic view of a display module structure according to an embodiment of the present application;

FIG. 12 is a schematic view of a reflection box structure according to an embodiment of the present application;

FIG. 13 is a first schematic view showing a fixed state of the reflection box according to an embodiment of the present application;

FIG. 14 is a second schematic view showing a fixed state of the reflection box according to an embodiment of the present application;

FIG. 15 is a schematic axial cross-sectional view according to an embodiment of the present application;

FIG. 16 is an exploded view of FIG. 12 according to an embodiment of the present application;

FIG. 17 is a schematic view of a second overall structure of the heating structure according to an embodiment of the present application;

FIG. 18 is an exploded view of the display module of FIG. 11 according to an embodiment of the present application; and

FIG. 19 is a schematic view of projection reflection according to an embodiment of the present application.

### LIST OF REFERENCE NUMERALS

1, housing. 11, oil reservoir. 12, atomization chamber. 13, suction channel. 14, air inlet. 15, sensing air passage. 16, fixing groove. 17, snap hook. 2, heating structure. 21, ceramic body. 211, wicking portion. 211a, top surface. 212, fixing portion. 2121, concave hole. 22, heating wire. 221, heating pin. 3, electronic control structure. 31, circuit board. 311, sensing module. 312, charging module. 313, switch module. 32, battery module. 33, display module. 331, display unit. 332, reflection box. 332a, reflective surface. 332b, display surface. 3321, fixing protrusion. 3322, snap-engaging protrusion. 40, display screen. 41, display area.

### DETAILED DESCRIPTION OF EMBODIMENTS

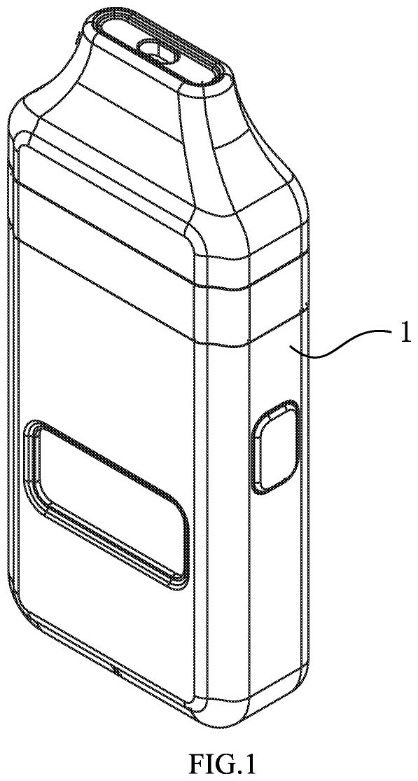

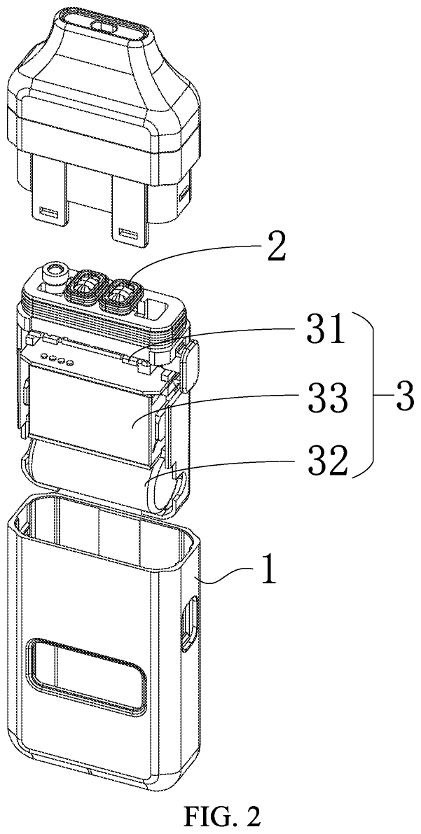

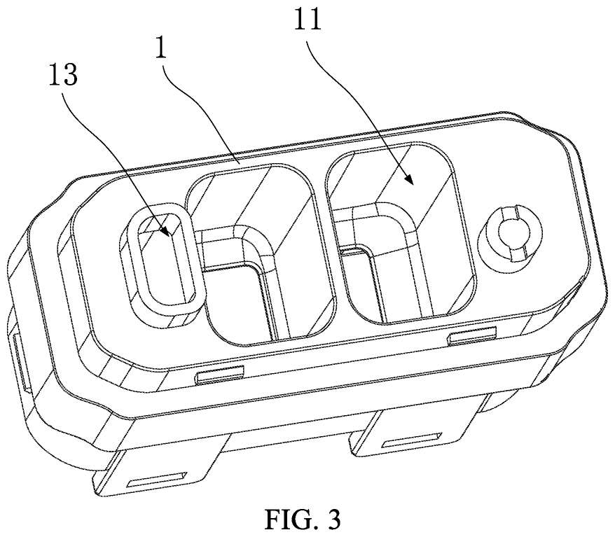

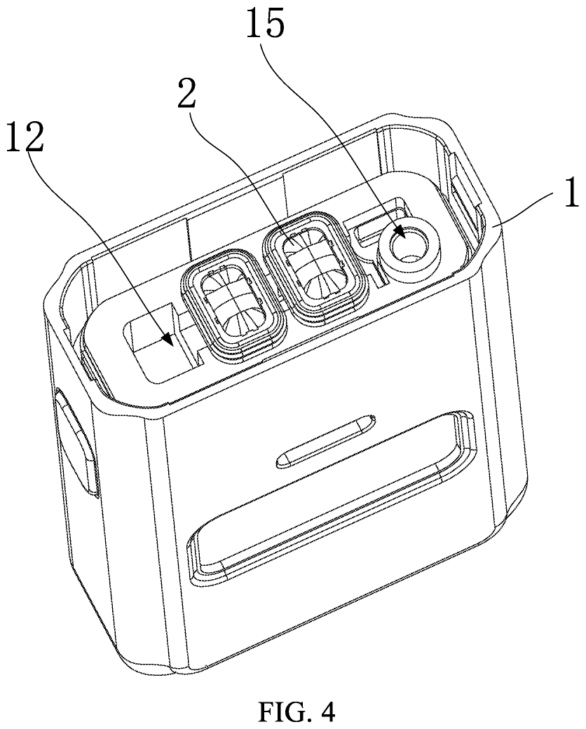

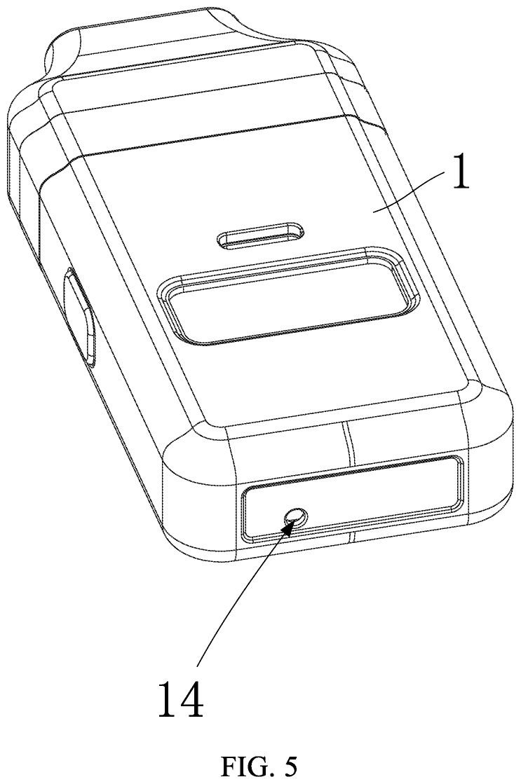

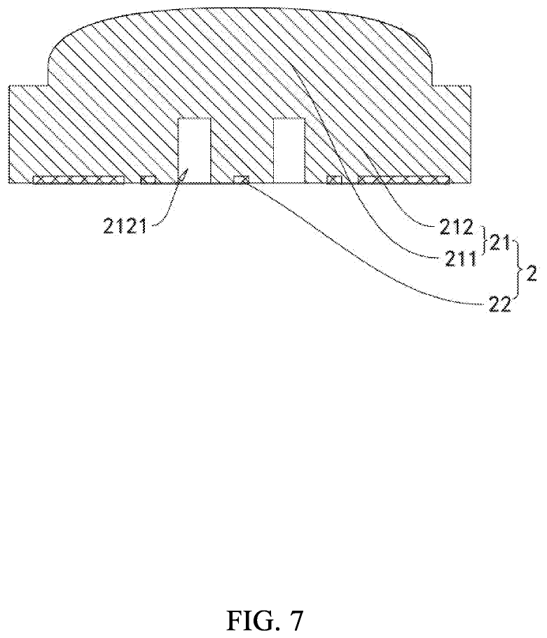

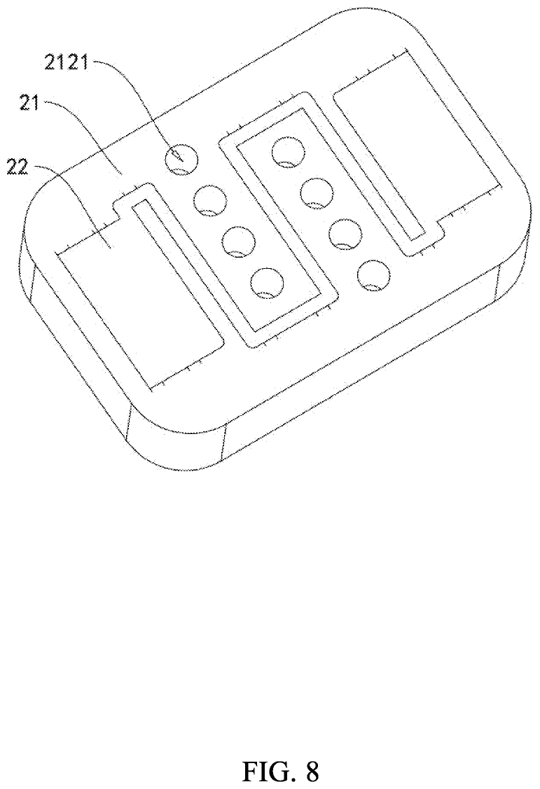

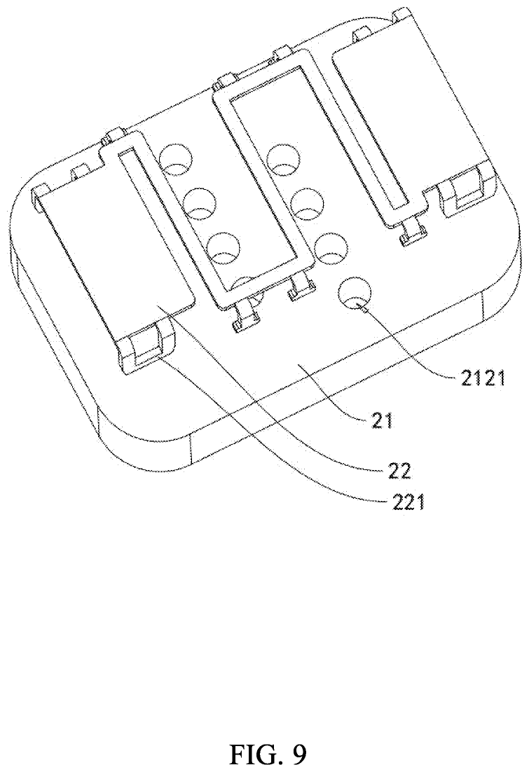

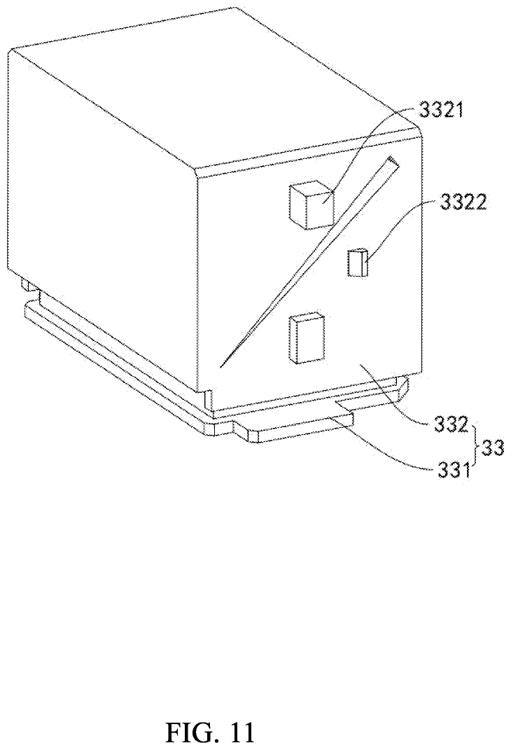

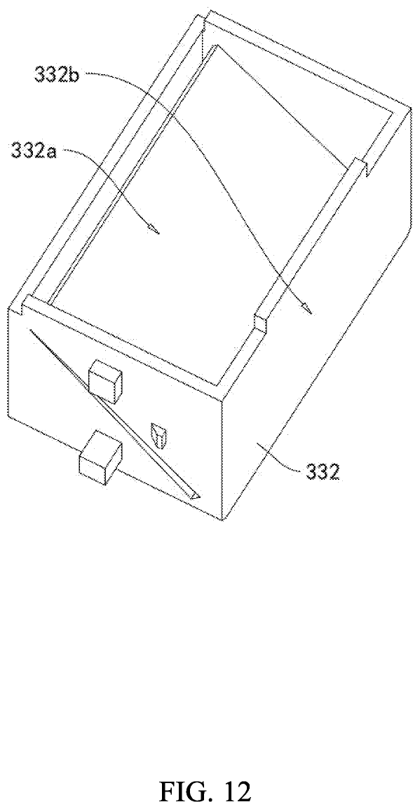

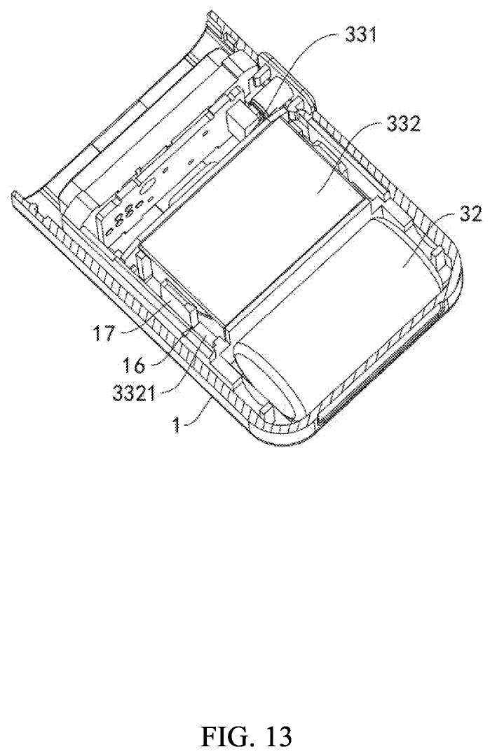

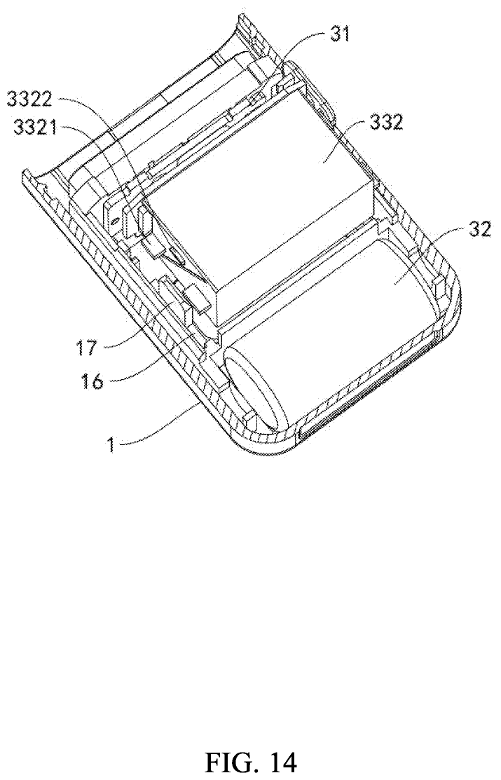

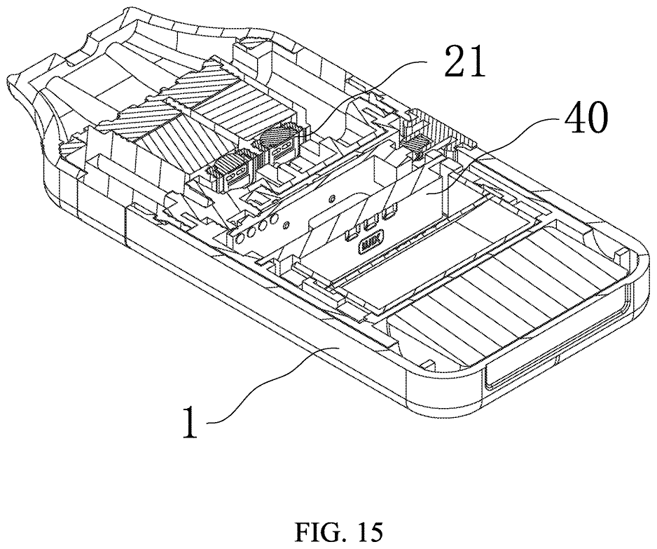

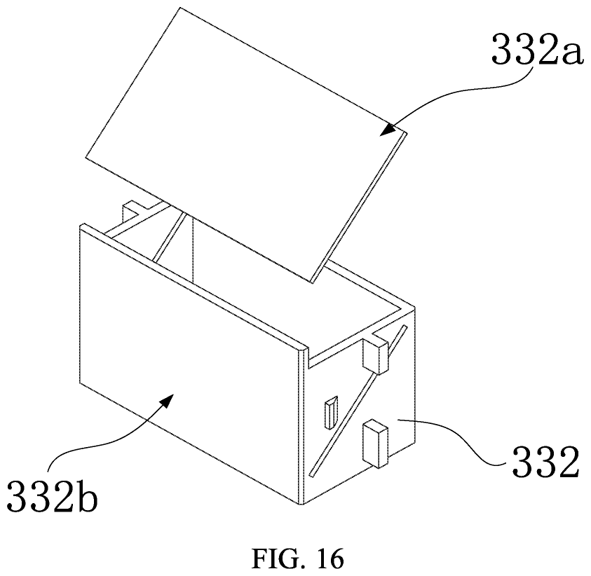

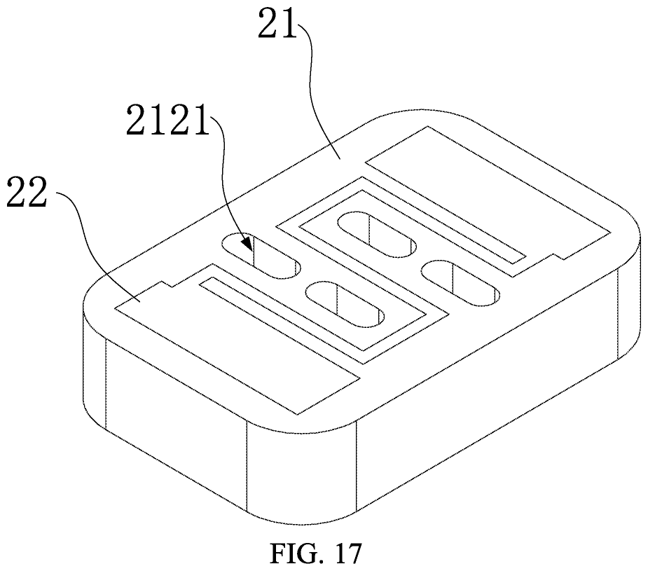

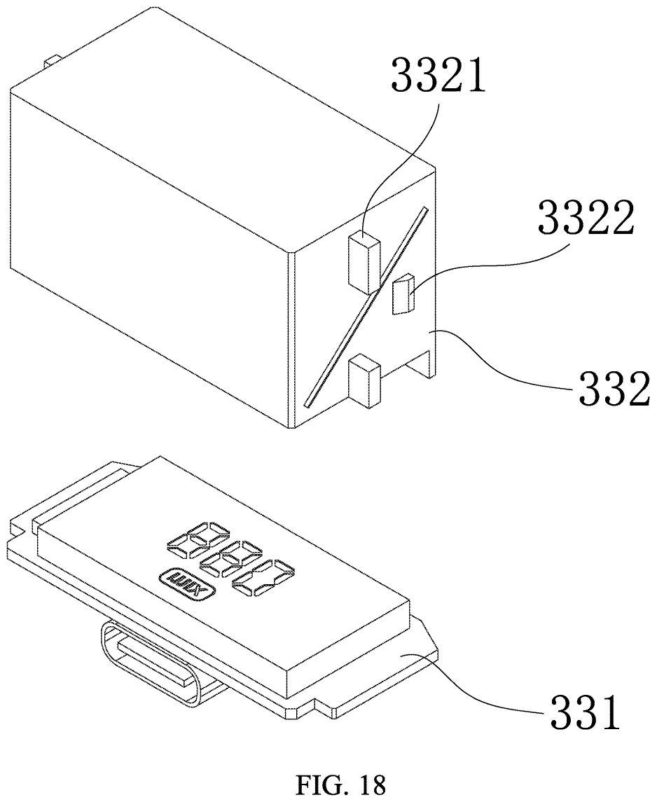

The present application will be further described in detail below with reference to FIGS. 1 to 18.

The embodiments of the present application disclose a heating structure and an electronic cigarette. Referring to FIGS. 1 to 5, an electronic cigarette includes a housing 1, a heating structure 2, and an electronic control structure 3. The housing 1 defines an oil reservoir 11 and an atomization chamber 12. The heating structure 2 is disposed between the oil reservoir 11 and the atomization chamber 12 and is configured to heat and atomize e-liquid in the oil reservoir 11 into aerosol in the atomization chamber 12. The electronic control structure 3 is disposed in the housing 1. It should be understood that the housing 1 is further provided with a suction channel 13 through which a user can inhale aerosol in the atomization chamber 12, an air inlet 14 through which outside air enters the atomization chamber 12, and a sensing air passage 15 that facilitates sensing of a user's inhalation action by the electronic control structure 3.

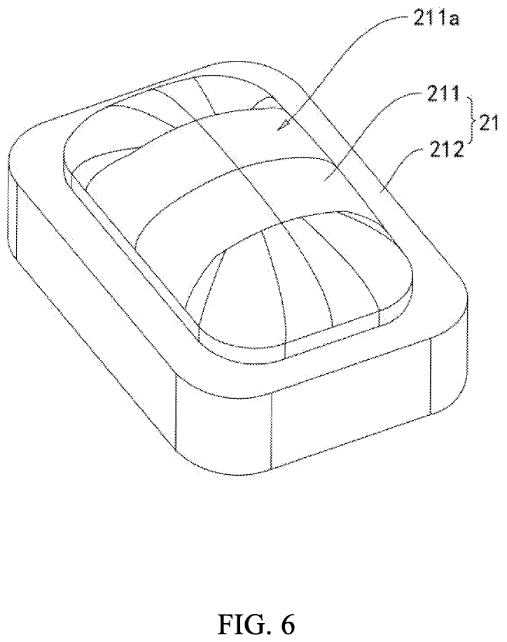

Referring to FIGS. 6 to 9, in the present embodiment, the heating structure 2 includes a ceramic body 21 and a heating wire 22. The ceramic body 21 includes a wicking portion 211 and a fixing portion 212. The wicking portion 211 and the fixing portion 212 are fixedly connected. The fixing portion 212 defines a plurality of concave holes 2121. The heating wire 22 is fixedly disposed on a side of the fixing portion 212 away from the wicking portion 211, such that e-liquid flows from the wicking portion 211 through the fixing portion 212 and is then heated and atomized into aerosol by the heating wire 22. In a preferred arrangement, the concave holes 2121 are formed on a side of the fixing portion 212 close to the heating wire 22 and are spaced apart from the heating wire 22 by a certain distance, and the hole bodies recess inwardly into the fixing portion 212 so as to form oil storage spaces configured to temporarily store e-liquid. It can be understood that, when e-liquid flows from the wicking portion 211 through the fixing portion 212, part of the e-liquid is stored in the concave holes 2121 under an action of surface tension thereof, thereby ensuring a quantity of e-liquid supplied to the heating wire 22.

In a further embodiment, the heating wire 22 extends to form a heating pin 221, and the heating pin 221 is located inside the fixing portion 212, that is, the heating pin 221 is inserted into the interior of the fixing portion 212, such that when e-liquid flows through the fixing portion 212, the heating pin 221 preliminarily heats e-liquid located in the fixing portion 212, thereby increasing flow efficiency of the e-liquid in the fixing portion 212, such that the e-liquid can more rapidly flow to the heating wire 22 for heating.

In a further embodiment, the wicking portion 211 has a top surface 211a away from the fixing portion 212, and the top surface 211a protrudes to form an arcuate surface, thereby increasing a contact area between the wicking portion 211 and the e-liquid, namely, a contact area between the top surface 211a and the e-liquid, such that the e-liquid can more rapidly permeate into the wicking portion 211, thereby increasing a speed at which the e-liquid flows to the heating wire 22.

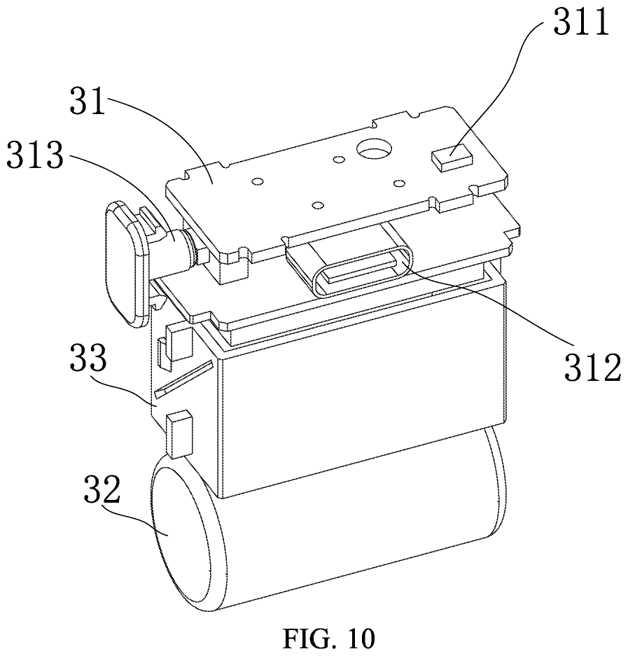

Referring to FIGS. 10 to 14, in the present embodiment, the electronic control structure includes a circuit board 31, a battery module 32, and a display module 33. The circuit board 31 is disposed in the housing 1 and is electrically connected to the heating structure 2, thereby supplying power to the heating structure 2. It can be understood that the electrical connection between the circuit board 31 and the heating structure 2 is an electrical connection between the circuit board 31 and the heating wire 22. The battery module 32 is disposed in the housing 1 and is electrically connected to the circuit board 31. The battery module 32 is configured to supply power to the circuit board 31. The display module 33 is disposed in the housing 1 and is electrically connected to the circuit board 31. The display module 33 is configured to display a status of the electronic cigarette. In addition, the display module 33 may also be used to display animated images having visual effects, thereby enriching a user's visual experience during use of the electronic cigarette.

In a preferred arrangement, the circuit board 31 is fixedly and electrically connected to a sensing module 311, and the sensing module 311 is located in the sensing air passage, such that when the user inhales, the sensing module 311 can feed back a signal of the user's inhalation action to the circuit board 31, thereby causing the circuit board 31 to supply power to the heating structure 2, such that the heating structure 2 heats and atomizes the e-liquid. In a further preferred arrangement, the circuit board 31 is fixedly and electrically connected to a charging module 312, so as to facilitate charging of the battery module 32 by the user. In a still further preferred arrangement, the circuit board 31 is electrically connected to a switch module 313 for controlling turning on or off of the electronic cigarette.

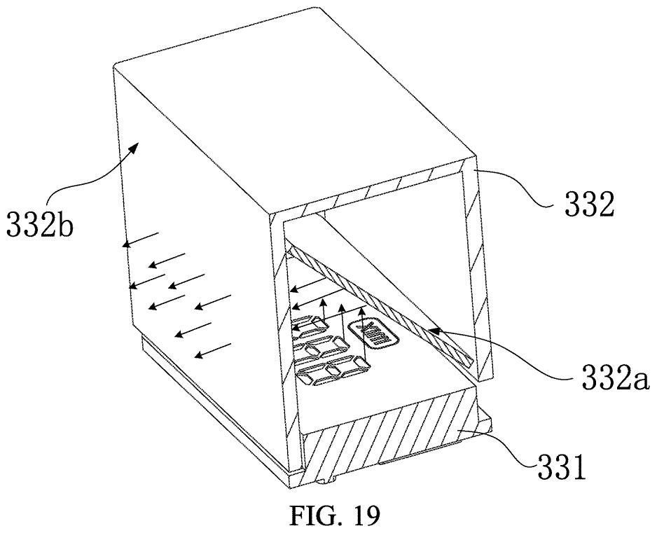

Referring to FIGS. 10 to 19, in a further embodiment, the display module 33 includes a display unit 331 and a reflection box 332. The reflection box 332 is connected to the display unit 331. The reflection box 332 has a reflective surface 332a and a display surface 332b. The reflection box 332 is configured to reflect light emitted from the display unit 331 by the reflective surface 332a onto the display surface 332b for display, such that patterns or animations displayed by the display module 33 as observed by the user exhibit an effect similar to a 3D animation, thereby improving a display effect of the display module 33. In addition, the arrangement enables the user to view a pattern or image displayed by the display unit 331 without directly seeing the display unit 331 from a front side, thereby making the electronic cigarette appear more concise and aesthetically pleasing. It should be understood that the reflective surface 332a is a mirror surface having a reflective effect, and the display surface 332b is a light-transmissive or semi-light-transmissive surface that facilitates passage of light therethrough.

Referring to FIGS. 10 to 14, in a still further embodiment, the reflection box 332 is fixedly provided with a fixing protrusion 3321, and the housing 1 defines a fixing groove 16. When the reflection box 332 is connected to the housing 1, the fixing protrusion 3321 extends through the fixing groove 16. It should be understood that the display unit 331 may be fixedly mounted to the reflection box 332 so as to realize fixed connection between the display unit 331 and the reflection box 332, or the display unit 331 may be snap-fitted and fixed to the housing 1. A specific fixing manner of the display unit 331 is not limited herein.

In a preferred arrangement, the reflection box 332 is fixedly provided with a snap-engaging protrusion 3322, and the housing 1 is fixedly provided with a snap hook 17. When the reflection box 332 is fixedly disposed in the housing 1, the snap hook 17 snap-engages with the snap-engaging protrusion 3322. It should be understood that the snap hook 17 has elasticity, that is, the snap hook 17 can elastically deform toward or away from the snap-engaging protrusion 3322. When the reflection box 332 is fixedly connected to the housing 1, the fixing protrusion 3321 extends through the fixing groove 16 and the snap hook 17 snap-engages with the snap-engaging protrusion 3322. At this time, when the reflection box 332 drives the snap-engaging protrusion 3322 to move in a direction away from the snap hook 17, the fixing groove 16 limits movement of the fixing protrusion 3321, thereby limiting movement of the reflection box 332. When the reflection box 332 drives the fixing protrusion 3321 to move in a direction away from the fixing groove 16, the snap hook 17 limits movement of the snap-engaging protrusion 3322, thereby limiting movement of the reflection box 332, thereby realizing fixation between the reflection box 332 and the housing 1. When the reflection box 332 needs to be detached from the housing 1, a certain external force is applied to the snap hook 17, such that the snap hook 17 elastically deforms, thereby disengaging the snap hook 17 from the snap-engaging protrusion 3322 and enabling the reflection box 332 to be detached from the housing 1. In other embodiments, the fixed connection between the reflection box 332 and the housing 1 may also be realized by other fixing manners, for example, by bolts.

The operating principle of the electronic cigarette according to the embodiments of the present application is as follows: when e-liquid permeates into the ceramic body 21 through the wicking portion 211, flows through the fixing portion 212, and is finally heated and atomized into aerosol by the heating wire 22, the concave holes 2121 in the fixing portion 212 form oil storage spaces for storing e-liquid when the e-liquid flows through the fixing portion 212, such that when the heating wire 22 is operating and lacks e-liquid, the concave holes 2121 rapidly provide e-liquid to the heating wire 22 to facilitate atomization by the heating wire 22, thereby ensuring that the e-liquid delivered to the heating wire 22 remains sufficient at all times. As a result, occurrence of burnt and off-flavored e-liquid caused by the heating wire 22 is reduced, thereby ensuring flavor fidelity of the e-liquid and improving over the problem that, in order to ensure structural strength of the ceramic body 21, the number of micropores in the ceramic body 21 is generally limited, which in turn results in a relatively low wicking speed of the ceramic body 21 and insufficient e-liquid delivered to the heating wire, causing the heating wire to excessively heat the e-liquid such that aerosol generated from the atomized e-liquid becomes burnt and develops an off-flavor, thereby resulting in poor inhalation taste.

The foregoing are merely preferred embodiments of the present application and are not intended to limit the protection scope of the present application. Accordingly, any equivalent changes made according to the structure, shape, and principle of the present application shall fall within the protection scope of the present application.

What is claimed is:

1. A heating structure, comprising a ceramic body and a heating wire, wherein the ceramic body comprises a wicking portion and a fixing portion, the wicking portion and the fixing portion being fixedly connected, the fixing portion defining a plurality of concave holes, and the heating wire being fixedly disposed on a side of the fixing portion away from the wicking portion, such that e-liquid flows from the wicking portion through the fixing portion and is then heated and atomized into aerosol by the heating wire.

2. The heating structure according to claim 1, wherein the heating wire extends to form a heating pin, and the heating pin is located inside the fixing portion.

3. The heating structure according to claim 1, wherein the wicking portion has a top surface away from the fixing portion, and the top surface protrudes to form an arcuate surface.

4. An electronic cigarette, comprising the heating structure according to claim 1, a housing, and an electronic control structure, wherein the housing defines an oil reservoir and an atomization chamber, the heating structure is disposed between the oil reservoir and the atomization chamber and is configured to heat and atomize e-liquid in the oil reservoir into aerosol in the atomization chamber, and the electronic control structure is disposed in the housing.

5. The electronic cigarette according to claim 4, wherein the electronic control structure comprises a circuit board, a battery module, and a display module, the circuit board being disposed in the housing and electrically connected to the heating structure, the battery module being disposed in the housing and electrically connected to the circuit board, the battery module being configured to supply power to the circuit board, and the display module being disposed in the housing and electrically connected to the circuit board, the display module being configured to display a status of the electronic cigarette.

6. The electronic cigarette according to claim 5, wherein the display module comprises a display unit and a reflection box, the reflection box being connected to the display unit, the reflection box having a reflective surface and a display surface, and the reflection box being configured to reflect light emitted from the display unit by the reflective surface onto the display surface for display.

7. The electronic cigarette according to claim 6, wherein the reflection box is fixedly provided with a fixing protrusion, the housing defines a fixing groove, and when the reflection box is connected to the housing, the fixing protrusion extends through the fixing groove.

8. The electronic cigarette according to claim 7, wherein the reflection box is fixedly provided with a snap-engaging protrusion, the housing is fixedly provided with a snap hook, and when the reflection box is fixedly disposed in the housing, the snap hook snap-engages with the snap-engaging protrusion.
